(19) United States
(12) Patent Application Publication
(10) Pub. No.: US 2007/0260438 A1
(43) Pub. Date: Nov. 8, 2007

(54) Vehicle testing and simulation using integrated simulation model and physical parts

(76) Inventors: William J. Langer, Minnetrista, MN (US); Daniel Barsness, Victoria, MN (US)

Correspondence Address: MCDERMOTT, WILL & EMERY, 4370 LA JOLLA VILLAGE DRIVE, SUITE 700, SAN DIEGO, CA, 92122, US

(21) Appl. No.: 11/430,427

(22) Filed: May 8, 2006

(51) Int. Cl. G06G 7/48

(52) U.S. Cl. 703/8

(57) ABSTRACT

A vehicle tester using integrated simulation model and physical parts under test for determining effects of the physical parts to a complete vehicle incorporating the parts. A simulation model representing the vehicle excluding the physical parts is provided. A test scenario is applied to the simulation model. The response of the simulation model is translated to a test condition applying to the physical parts under test, to obtain the physical parts response to the test condition in real time. Responses and changes occurred on the parts under test are dynamically obtained and incorporated into a calculation of the effects of the physical parts to the vehicle using the simulation model. A report of the calculated effects is then generated.

### FIELDS OF DISCLOSURE

This application generally relates to vehicle testing and evaluations, and more specifically, to a testing system and method using integrated vehicle model and physical parts that obtain and incorporate actual reactions of the physical parts in performing vehicle simulations and tests.

### BACKGROUND

This application generally relates to vehicle testing and evaluations, and more specifically, to a testing system and method using integrated vehicle model and physical parts that obtain and incorporate actual reactions of the physical parts in performing vehicle simulations and tests.

Alternately, the time history can obtained using laboratory simulations, such as tests performed based on a representative vehicle and replicated on a laboratory test rig. In addition, time histories representing ideal maneuvers such as constant turning can be derived from a vehicle model. In laboratories simulations, either measured time histories or idealized time histories are applied to the subsystem only. The resulting subsystem loads or displacements are reduced to engineering terms such as parameter maps, gradients or frequency response functions. The reduced engineering terms of subsystem performance are used to deduce resultant vehicle behavior through a vehicle model applied after the test results. The limitation in this type of simulations is that an implied model is assumed for the subsystem. The assumed model may ignore important subsystem characteristics. This is especially true for characteristics that might manifest during a transient input. Furthermore, changing subsystem characteristics are not captured by this type of simulations, either. A subsystem that has characteristics changing based on recent history or unmodeled parameters, such as temperature, will not develop measurements on a laboratory rig that accurately predict vehicle behavior.

Some primitive simulations or testers apply test conditions only to the component or subsystem, without considering the influence of the subsystem on the vehicle behavior. This type of simulations assumes that characteristics of the component or subsystem under test remain unchanged during the test process, and hence the testing conditions and vehicle models do not change. However, in reality, characteristics of the component under durability tests change over time, and in turn affect the vehicle model and test parameters or test conditions. For instance, a vehicle suspension under test may change as a load history is applied repeatedly. On the road, this would mean that the actual loads applied to the suspension also change because of its changing interaction with the vehicle and the road. If the simulation does not consider the changes in the test parameters or conditions, the test result would be unreliable. Thus, the obtained measurements are limited to the performances of the subsystem or parts under test. The influence of the subsystem or part under test on the vehicle behavior is not known directly and in a real time manner.

The proliferation of electromechanical systems, also known as mechatronics, in a variety of different vehicles has recently increased as well. No longer reserved for engines and transmissions alone, mechatronic systems are now available for dampers, steering systems, sway-bars, as well as other vehicle systems. As the breadth and technical capability of mechatronics applications increase, so do the design, calibration, and troubleshooting challenges.

Therefore, there is a need to test vehicle subsystems and/or parts without the need to use a complete vehicle with finalized design. There is also a need to determine influence of the subsystem/part under test on the vehicle behavior in real time. There is another need to provide simulations having characteristics of physical parts and/or subsystems interact with a vehicle model as the subsystems/parts would with a real vehicle. There is an additional need to apply test conditions that dynamically interact with the changing characteristics of subsystems/parts under test. There is still another need to provide a vehicle simulation and testing with integrated vehicle model and physical parts, to effectively capture characteristics of the subsystem and/or parts under test in a physical test environment that considers and addresses interactions between vehicle parts under test and the rest of the vehicle. Moreover, there is a need to provide a vehicle model that dynamically addresses the changes in the characteristics of the component under test.

### SUMMARY

This disclosure describes embodiments of vehicle simulations that address some or all of the above-described needs. An exemplary tester for simulating characteristics of a vehicle incorporating a subsystem under test, includes at least one test rig actuator configured to apply a test condition to the subsystem, at least one sensor configured to collect signals related to the subsystem, and a data processing system. The data processing system includes a data processor for processing data, a data storage device configured to store machine-executable instructions and data related to a simulation model representing the vehicle not including the subsystem. The instructions, upon executed by the data processor, control the data processing system to generate a set of test signals based on simulation model, control the at least one test rig actuator to apply a test condition to the subsystem based on the test signals, and obtain a response of the subsystem to the applied test condition. The data processing system calculates effects of the subsystem to the vehicle using the simulation model incorporating information related to the response of the subsystem to the applied test condition, and generates a result of the calculated effects. The tester may include a test platform configured to support the subsystem or a vehicle incorporating the subsystem. The subsystem may include at least one of a suspension system, at least one wheel and at least one tire. The generated result may include information related to at least one of fuel efficiency of the vehicle, ride comfort of the vehicle, needed time around a selected course and a distance. In one aspect, the test condition includes applying at least one of a vertical displacement, a spin of a wheel of the subsystem, a vertical force, a lateral force and a longitudinal force. In another aspect, the data storage device stores data of simulation models representing a plurality of vehicle models.

In one embodiment, the data related to the simulation model is modified based on the received response of the subsystem. The data processing system generates a new test signal using the modified simulation model of the vehicle, and controls the at least one actuator to apply a test condition to the subsystem based on the new test signal. In another embodiment, the response of the subsystem includes at least one of a lateral force of a tire of the subsystem, a normal force of the tire of the subsystem, a deflection angle, a camber angle, a vertical force and aligning torque.

The data processing system may generate a new set of test signals based on the obtained response of the subsystem. In another embodiment, the instructions, upon being executed by the data processor, further control the data processing system to control the at least one test rig actuator to apply a test condition to the subsystem based on the new set of test signals. According still another embodiment, the instructions, upon being executed by the data processor, further control the data processing system to generate a test report including characteristics of the vehicle based on the response signals of the subsystem and the simulation model.

An exemplary method for testing a subsystem for use in a vehicle includes the machine-executed steps of providing a simulation model representing the vehicle not including the subsystem, generating a set of test signals based on simulation model, applying a test condition to the subsystem based on the test signals, and obtaining a response of the subsystem to the applied test condition. Effects of the subsystem to the vehicle are calculated using the simulation model incorporating the response of the subsystem to the applied test condition. A result of the calculated effects is then generated. In one aspect, the generated result includes information related to at least one of fuel efficiency of the vehicle, ride comfort of the vehicle, needed time around a selected course and a distance. In one embodiment, the method further includes the step of modifying the simulation model based on the received response signals of the subsystem. A new test signal may be generated using the modified simulation model of the vehicle, and a test condition based on the new test signal is applied to the subsystem. According to another embodiment, a test report including characteristics of the vehicle based on the response signals of the subsystem and the simulation model is generated.

The foregoing and other features, aspects and advantages of the disclosed embodiments will become more apparent from the following detailed description and accompanying drawings.

### BRIEF DESCRIPTION OF THE DRAWINGS

The present disclosure is illustrated by way of example and not by way of limitation, in the figures of the accompanying drawings and in which like reference numerals refer to similar elements.

FIGS. 1a and 1b show an active roll control system.

FIGS. 2a and 2b illustrate the effects of an active roll control system to a vehicle.

FIG. 3 depicts a block diagram of an exemplary tester.

FIG. 4 shows an exemplary construction of a tester according to this disclosure.

FIG. 5 shows another exemplary construction of a tester according to this disclosure.

FIG. 6a illustrates subsystems of a vehicle.

FIG. 6b depicts a simplified block diagram representing the tester shown in FIG. 1.

FIG. 7 depicts a flowchart of an exemplary method of operation of the tester of FIG. 6b.

FIG. 8 is an exemplary data processing system upon which an embodiment of this disclosure may be implemented.

### DETAILED DESCRIPTION OF ILLUSTRATIVE EMBODIMENTS

For illustration purposes, the following descriptions describe various illustrative embodiments of a physical tester for testing a vehicle, such as an automobile, airplane, etc., and/or one or more subsystems thereof, such as an actively controlled suspension system, active rolling control system, etc.

The exemplary tester utilizes a specially designed simulation model that dynamically obtains and incorporates characteristics of a physical subsystem under test into simulations of the behaviors of a vehicle and/or the subsystem under test without the need for a completed vehicle. It will be apparent, however, to one skilled in the art that concepts of the disclosure may be applied to other types of subsystems or parts of a vehicle, or may be practiced or implemented without these specific details. In other instances, well-known structures and devices are shown in block diagram form in order to avoid unnecessarily obscuring the present disclosure.

An automobile includes various subsystems for performing different functions such as power train, driver interface, climate and entertainment, network and interface, lighting, safety, engine, braking, steering, chassis, etc. Each subsystem further includes components, parts and other subsystems. For instance, a power train subsystem includes a transmission controller, a continuously variable transmission (CVT) control, an automated manual transmission system, a transfer case, an all wheel drive (AWD) system, an electronic stability control system (ESC), a traction control system (TCS), etc. A chassis subsystem may include active dampers, magnetic active dampers, body control actuators, load leveling, anti-roll bars, etc. Deigns and durability of these subsystems need to be tested and verified during the design and manufacturing process.

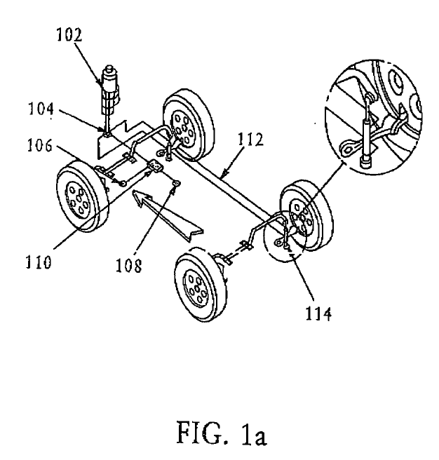

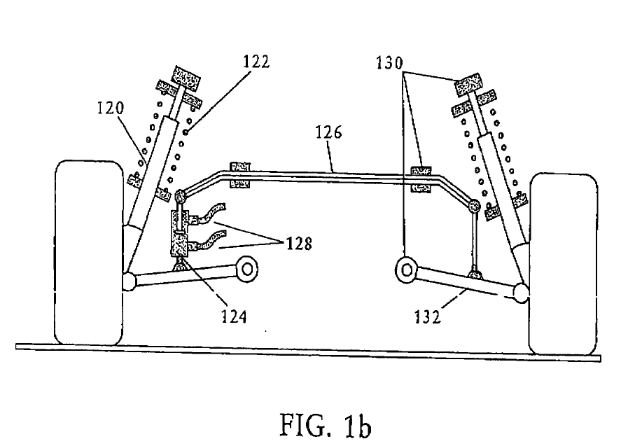

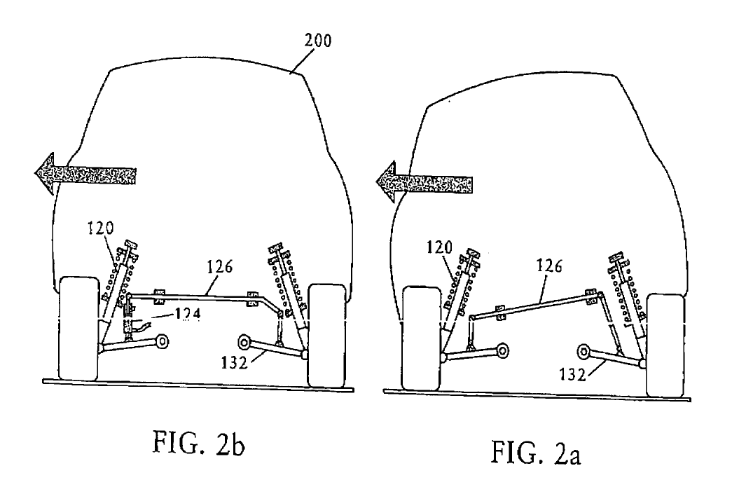

Some of the subsystems use electronic control units (ECU) that actively monitor the driving condition of a vehicle and dynamically adjust the operations and/or characters of the subsystems, to provide better control or comfort. FIGS. 1a and 1b show an exemplary active roll control system of an automobile. The active roll control system of the example includes a motor pump assembly 102, a valve block 104, a steering angle sensor 106, a lateral accelerometer 108, an electronic control unit (ECU) 110, hydraulic lines 112 and linear actuators 114. FIG. 1b depicts such an active system along with other components of a vehicle's suspension. Thus, a McPherson strut, a spring 122, an actuator 124, a stabilizer bar 126, a cross-over valve connector 128, bushings 130, and a control arm 132 are depicted as components of an exemplary suspension system. As illustrated in FIG. 2a, if an automobile does not have an active roll control system, the cornering force can cause a significant body lean of the automobile when making turns. On the other hand, as shown in FIG. 2b, if an automobile is equipped with an active roll control system, once the ECU 110 determines that the automobile is making a turn, it controls the actuator 124 to deflect the stabilizer bar 126, which minimizes the body lean of the automobile 200 when making a turn.

Another example of active subsystems is an actively controlled suspension system. An actively controlled suspension system includes an ECU, adjustable shocks and springs, a series of sensors at each wheel and throughout the car, and an actuator or servo atop each shock and spring. When the automobile drives over a pothole, the sensors pick up yaw and transverse body motion, and sense excessive vertical travel due to the pothole. The ECU collects, analyzes and interprets the sensed data, and controls the actuator atop the shock and spring to “stiffen up.” To accomplish this, an engine-driven oil pump sends additional fluid to the actuator, which increases spring tension, thereby reducing body roll, yaw, and spring oscillation.

System Architecture

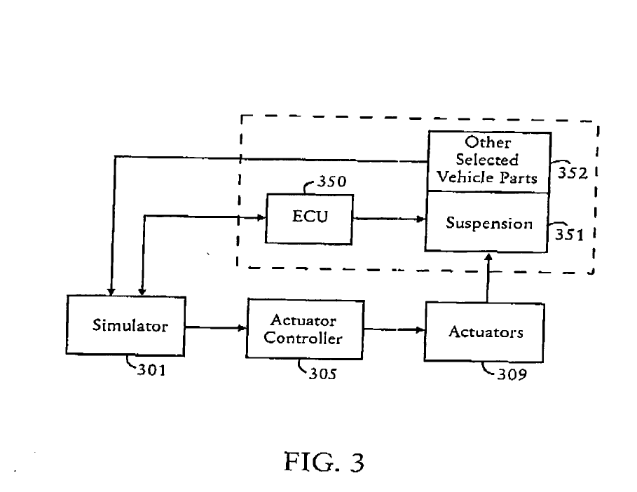

FIG. 3 depicts a block diagram of an exemplary tester that tests an actively controlled suspension system of a vehicle. The exemplary tester utilized a specially designed simulation model that dynamically obtains and incorporates characteristics of a physical subsystem under test into simulations of the behaviors of a vehicle and/or the subsystem under test without the need for a completed vehicle.

The exemplary tester includes a simulator 301 incorporating a real-time vehicle simulation model, an actuator controller 305 and actuators 309. An actively controlled suspension system includes ECU 350 and a vehicle suspension 351. A test may be performed on suspension 351 alone, or with other selected physical vehicle parts 352, such as a wheel and a tire.

Simulator 301 performs real-time simulations of the operation of a vehicle under selected test conditions based on a specially deigned simulation model related to a vehicle that would incorporate suspension 351 under test. The construction and use of the simulation model reflects a test environment in which suspension 351 is tested, such as whether suspension 351 is tested alone or when it is attached with other vehicle parts 352. The simulation model represents characteristics of the vehicle excluding suspension 351 under test and other selected physical parts 352 used during the test. Physical parts of the vehicle or suspension that do not exist during the test or are not yet available are modeled and incorporated into the simulation model. Depending on the existence and types of other selected physical parts used in the test of suspension 351, the simulation model may include other information such as engine, power train, suspension, wheel and tires, vehicle dynamics, aerodynamics, driver behavior patterns, road conditions, brakes, body mass, center of gravity, passenger load, cargo load, body dimensions, thermal dynamic effects, clutch/torque converter, driver behaviors, etc. Modeling techniques are widely used and known to people skilled in the art. Companies supplying tools for building simulation models include Tesis, dSPACE, AMESim, Simulink. Companies that provide simulators include dSPACE, ETAS, Opal RT, A&D, etc. Detailed descriptions of construction of the specially designed simulation model in simulator 301 will be described shortly.

Simulator 301 has access to a test condition database which includes data related to a road profile, driving course, a driver's inputs, a surface definition, a driver model, test scenario, acceleration, speed, direction, driving maneuvers, braking, etc. In one embodiment, a road profile includes a map of the road surface elevation versus distance traveled, vehicle turns, road vibrations, etc. The driver's inputs may be pre-stored or input by an operator of the tester. The operator may follow an arbitrary sequence (open loop driving), or the operator may adjust inputs in response to the current vehicle path as seen on a display of the tester (closed loop driving). The inputs include brake pressure, throttle position and steer wheel position, and any inputs that may be entered by a driver. In one embodiment, information related to the test condition database is incorporated into the simulation model. Suspension ECU 350 is provided to control vehicle suspension 351 based on input signals sent by simulator 301.

An exemplary simulator 301 is implemented using a data processing system, such as a computer, that includes one or more data processors for processing data, a data storage device configured to store instructions and data related to the simulation model, test condition database, etc. The instructions, when executed by the data processor, controls simulator 301 to perform functions specified by the instructions.

In operation, simulator 301 generates control signals to actuator controllers 305 based on the simulation model and data stored in the test condition database, such as a test scenario, to initiate applications of a test condition to suspension 351 by actuators 309. Exemplary test conditions applied by actuators 309 include a vertical displacement, a spin of a wheel/tire attached to suspension 351, a vertical force, a lateral force, a longitudinal force, etc., or any combinations thereof.

Furthermore, simulator 301 provides ECU 350 with information related to the operation of the vehicle under the specific test condition using the simulation model. For instance, the simulation model simulates the vehicle dynamics and driver's inputs from either a file or directly from an operator. Simulator 301 computes vehicle velocity and the loads that the chassis would impose on suspension 351 from acceleration. The driver's inputs consist of throttle position, brake pressure and optionally steer wheel displacement.

In one embodiment, the simulation model includes a power train model assuming power proportional to throttle position. Interrupted power according to a shift schedule will result in a change in body force actuator command due to the acceleration transient, similar to the road. Driver's brake input will result in a braking force in the vehicle dynamics model resulting in a decrease in vehicle speed and change in body force due to deceleration. Acceleration will determine the inertial load transfer to the suspension. Road loads for grade, air resistance and rolling loss are combined with vehicle inertia and power train output to determine vehicle displacement, velocity and acceleration along the road path. Road vertical displacement will be applied as in a real road. Path acceleration will determine the inertial load transfer to the suspension. A steering input may also be considered. Steer input will result in lateral and yaw velocity changes for the simulated vehicle. A tire model can be used to produce the lateral forces as a function of slip angle and normal force. For simplicity, the road profile may be superimposed on the path that the vehicle takes to eliminate the necessity of an x-y description of the road plane. Steering inputs will result in a change in normal force to the suspension corner under test.

Based on the information provided by simulator 301, ECU 350 sends out commands to change characteristics of suspension 351, which in turn change the resulting body and suspension loads/position of the simulated vehicle incorporating suspension 351 under test. Sensors (not shown) are provided at appropriate locations to obtain signals related to the responses of suspension 351 to test conditions applied by actuators 309 and changes of physical characteristics initiated by ECU 350. Examples of the response signals include a lateral force of a wheel/tire attached to suspension 351, a normal force of the wheel/tire attached to suspension 351, a deflection angle of the steering system, a camber angle, a vertical force and aligning torque, etc.

Furthermore, commands sent by ECU 350 are also made available to simulator 301. Based on the response signals of suspension 351, and commands sent by ECU 305, simulator 301 performs collective evaluation of software, electronic and physical characteristics with actual or simulation loads. Data collected during the test is further used to perform evaluations of the actively controlled suspension system including suspension characterization and/or measurement based on the vehicle under test, designs of ECU 350, suspension 351, vehicle performance characterization and/or measurement based on the suspension under test, durability testing, model identification and verification, algorithm and control strategy development, algorithm validation, ECU calibration, regression testing, multiple system integration, etc. In one embodiment, simulator 301 calculates the effects of suspension 351 to the vehicle by using the simulation model incorporating the response of suspension 351 to the applied test condition. A test result may be generated including information listed above. The above-described steps are repeated during the test.

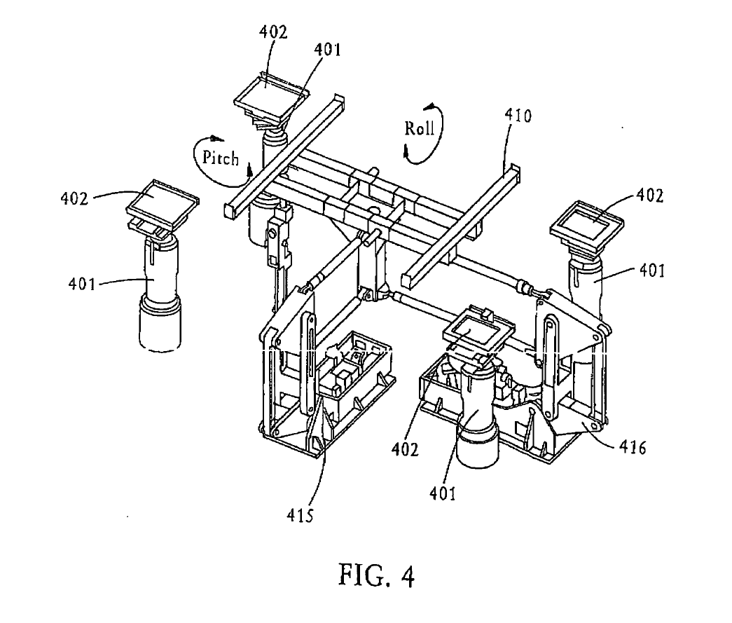

FIG. 4 shows an exemplary hardware construction of an exemplary tester for testing characters of a suspension system. Posters 401 and supporting plates 402 are provided to support wheels or other subsystems of a vehicle. A supporting frame 410 provides support from underneath the body of a vehicle, if one is available. Each poster 401 includes an actuator for applying a vertical force to the respective wheel of a vehicle and/or moving the respective supporting plate 402 in a vertical direction. Two additional actuators 415 and 416 are attached to supporting frame 410, to provide at least one of a lateral force, a longitudinal force, a roll or pitch motions or forces to a vehicle under test. Additional actuators may be provided to apply additional force or movements in additional dimensions. The actuators are controlled by simulator 301 and actuator controller 305 to apply forces and/or movements to a suspension system and/or vehicle under test according to one or more test conditions specified by simulator 301. It is understood that depending on design preference, different types or combinations of actuators can be provided to posters 401, supporting plates 402 and supporting frame 410, to move or apply forces to the subsystem and/or vehicle under test in different dimensions.

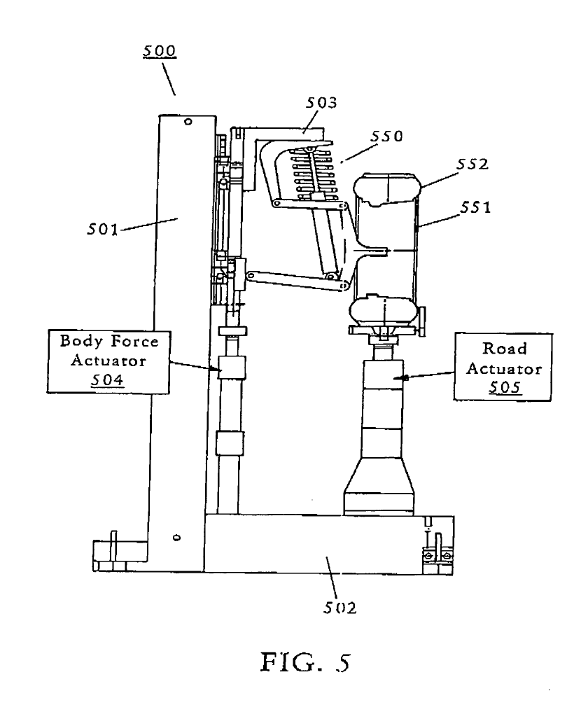

FIG. 5 shows another exemplary hardware construction of a tester 500 according to this disclosure. Tester 500 includes a poster 501, a base 502 and a weighted control arm 503. Control arm 503 hinges on one end and has a suspension 550 mounted to the other end. Suspension 550 is guided by weighted control arm 503 in the vertical direction. A wheel module including wheel 551 and tire 552 is attached to suspension 550. A body force actuator 504 is provided to apply a force to the body side of suspension 550 corresponding to static weight on suspension 550, force transfer due to braking and/or acceleration, and force transfer due to cornering. In one embodiment, body force actuator 504 has swivels on both ends and is connected to weighted control arm 503. A road actuator 505 is located under tire 552 and supplies road displacement inputs or forces to suspension 550.

Similar to the embodiment shown in FIG. 4, road actuator 505 and body force actuator 504 are controlled by simulator 301 and actuator controller 305 to apply forces and/or movements to a suspension system and/or vehicle under test according to one or more test conditions specified by simulator 301. The responses of suspension 550 to the test conditions are collected by properly positioned sensors, and sent to simulator 301 for further processing.

Designs of Simulation Model

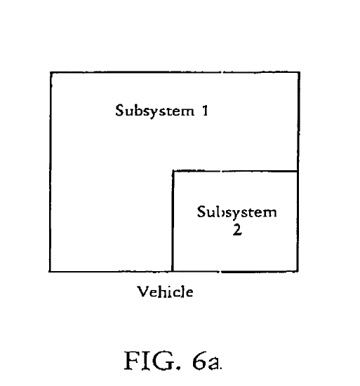

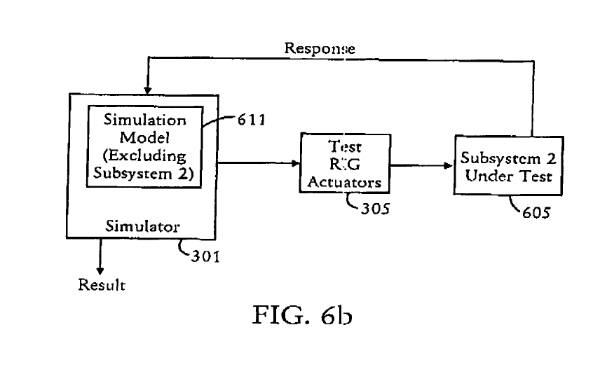

The construction and operation of the simulation model used in simulator 301 are now described. As shown in FIG. 6a, a vehicle consists of subsystem 1 and subsystem 2. In one embodiment, subsystem 2 is a suspension system undergoing a test, and subsystem 1 is everything on the vehicle other than subsystem 2. FIG. 6b is a simplified block diagram of the exemplary tester shown in FIG. 1. ECU 350, suspension 351 and other selected vehicle parts 352 are shown generally as subsystem 2. Simulator 301 includes a simulation model representing characteristics of a vehicle excluding subsystem 2 under test. In other words, characteristics of the suspension under test are removed from the model.

In operation, the exemplary tester simulates a test scenario applied to a simulated vehicle excluding subsystem 2, and generates a first set of test signals using simulation model 611 and data stored in the test condition database. Based on the first set of test signals, test rig actuators 603 apply a test condition to subsystem 2. In other words, the simulation model is a real time model that simulates the behavior of the vehicle excluding subsystem 2 under a test scenario, and in real time, or with very short lag, calculates a response behavior of the simulated vehicle excluding subsystem 2 to the applied scenarios, and translates the response behavior to an appropriate test condition that corresponds to the test scenario for applying to subsystem 2. If subsystem 2 is a vehicle suspension, the applied test condition is in the form of displacements or loads applied to the vehicle suspension, for example. The loads and motions applied to subsystem 2 correspond to the loads and motions applied to the simulated vehicle model excluding subsystem 2.

Signals related to subsystem 2 and its responses to the applied test condition, such as complementary displacements or loads, are collected and sent to simulator 301. Based on the response of the simulated vehicle excluding subsystem 2 to the applied test scenario, and the received response of subsystem 2, simulator 301 determines the behavior of a complete vehicle by using both the actual characteristics of physical subsystem 2 and simulated response of vehicle excluding subsystem 2. This architecture provides real time knowledge of a broader range of test results, and offers a simplified test environment without the need for an iterative approach.

Referring to FIGS. 3 and 6b, in one embodiment, an exemplary tester performs an evaluation of effects of suspension 351 on a specific model of vehicle under a selected test scenario. Simulator has access to data related to the test scenario, such as road information related to a test course, certain assumptions of a test driving pattern like speed, acceleration, braking, steering maneuvers, sustention of G force, etc., and simulation model 611 corresponding to the selected vehicle. Based on the selected test scenario and simulation model 611, Simulator 301 generates appropriate control signals to test rig actuators 305 to apply a test condition to suspension 351. Suspension 351 may include at least one wheel/tire module. The applied test condition includes at least one of a vertical displacement, a spin speed of the wheel/tire module, a vertical force, a lateral force and a longitudinal force, etc, or any combination thereof. Responses of suspension 351 to the applied test condition are then measured. The responses of suspension 351 may include at least one of a vertical displacement, a spin of a wheel of the subsystem, a vertical force, a lateral force and a longitudinal force, or any combination thereof. The responses are sent to simulator 301. Simulator 301 then uses the responses of suspension 351 and simulation model 611 to calculate the effects of suspension 351 to the vehicle under the test scenario. In one embodiment, the responses of suspension 351 are used as input to simulation model 611 in calculating forces or changes in operations at driver contact points, such as driver seat, steering wheel, pedal feedback, vehicle body vibrations. Based on the calculated forces and/or changes at the driver contact points, simulator 301 calculates effects of suspension 351 to driving comfort of the vehicle. In another embodiment, the responses of suspension 351 are used as input to simulation model 611 in calculating fuel efficiency of the vehicle under the test scenario. According to still another embodiment, the responses of suspension 351 are used to calculate needed time around the selected course for the vehicle or a travel distance of the vehicle within a specified period of time. It is understood by people skilled in the art that effects of suspension 351 to other characteristics of the vehicle can also be calculated based on the responses of suspension 351 or any subsystems under test, using the concepts disclosed herein. Exemplary characteristics include vehicle acceleration, torque, durability, aerodynamics, brake distance, etc. The above-described steps are repeated during the test to generate a real-time result of the effects of suspension 351.

According to one embodiment, simulator 301, after obtaining the response of the subsystem 2, generates a new set of test signals by considering the effects and/or any changes of subsystem 2, so that any changes that may occur in the physical subsystem 2 under test are incorporated into the generation of test conditions. In response, test rig actuators 603 apply a new test condition to subsystem 2 according to the new set of test signals. The above-described steps are repeated during the test. For instance, responsive to the received response of subsystem 2, simulator 301 modifies the simulation model 611 by incorporating the response of subsystem 2 under test into the simulation model, so that the simulation model now considers any changes that may occur on the physical subsystem 2 under test, and generates appropriate test conditions and/or load histories for testing subsystem 2 based on the modified simulation model. The response of subsystem 2 may be used as inputs to the simulation model in place of the removed characteristics of the subsystem 2 under test. In this way, the physical subsystem 2 under test is inserted into a real time model of the full vehicle, road and driver.

The improved testing method is conducted as on the real test track with either an open loop or closed loop driver. The test rig, working with the simulation model and the subsystem applies loads to the physical subsystem under test in a way that will be similar to the loads developed on the real road. The test rig commands do not have to be known in advance, so iteration techniques to develop modified load time histories are not needed.

It is noted that the physical tester shown in FIG. 6b should be designed using minimum command tracking error. In other words, the time period between a command generated by simulator 301 to apply a specific test condition and the actual application of the test condition on subsystem 2 needs to be kept as short as possible, preferably less than 10 ms. Possible techniques for reducing the tracking error include inverse rig model and system identification techniques.

The improved tester allows tests to be performed without the need to gather road data with a full vehicle, allowing earlier testing than otherwise possible. The test process need not reduce the subsystem characteristics to engineering terms of an implied subsystem model. Rather, the real physical subsystem with all of its unmodeled characteristics interacts with the modeled vehicle as it would with a real vehicle. Moreover, because the vehicle subsystem interacts with the vehicle model through test rig feedbacks, changes in the vehicle subsystem characteristics will result in changes in applied load, as will happen on the real road. This results in more realistic subsystem testing. The effect of the subsystem on vehicle behavior is measured directly in the vehicle model, just as the more inconvenient road test measures vehicle behavior directly. Additionally, the effect of the vehicle model on the subsystem behavior is measured directly with the rig transducers, just as the effect of real road test allowing direct measurement of subsystem behavior. Using the exemplary tester, it is also possible to test the subsystem under conditions representing those that would occur on the road, without the need for a real vehicle or road, which may not be available at the time of test.

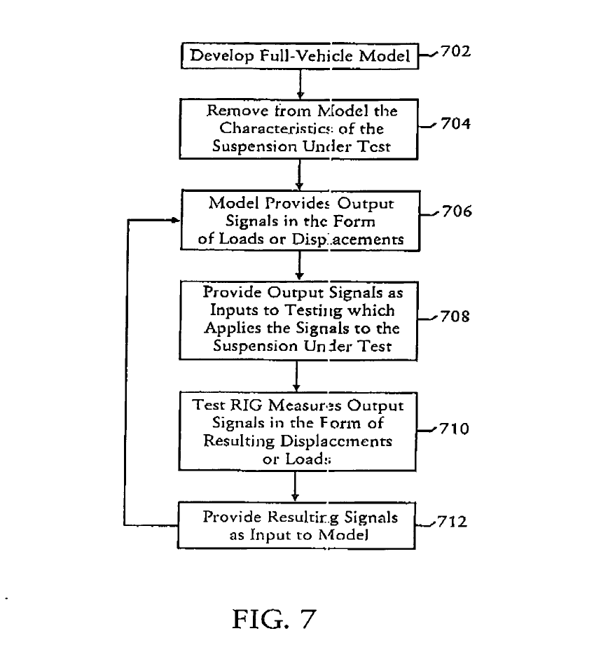

FIG. 7 depicts a flowchart that summarizes an exemplary method of operation of the tester just described. In step 702, a real-time model of a full vehicle is developed. As described earlier, many different types of models may be developed for the vehicle. In step 704, the part of the model that represents some or all of the suspension system is removed from the vehicle model. This portion may be the entire suspension system or individual components of that system. Next, in step 706, the model is executed so as to simulate the operation of the vehicle over a particular road. As a result, the vehicle model produces output signals that it would normally provide to omit portion of the model (i.e., the suspension system). These output signals represent loads or displacements that operate on the suspension system. In step 708, these output signals are provided as input to a test rig. As a result, the test rig applies actual loads and displacements to a physical test specimen. The result is that the physical test specimen will move and deflect in a particular way. Thus, the test rig detects and measures, in step 710, the resulting loads and displacements exhibited by the physical specimen under test. These resulting signals are provided, in step 712, as inputs to the vehicle model. The process can then repeat itself in substantially real-time so that a physical test specimen can be included along with the remaining vehicle model when testing vehicle suspension design and performance. Based on the vehicle model selected, the signals provided as output from the test specimen may be determined. As would be known to one of ordinary skill, detection and measuring equipment is selected and located appropriately so as to provide the resulting displacement and load signals that are fed back to the vehicle model. In one embodiment, the tester generates reports regarding test conditions of at least one of a vehicle incorporating the physical parts under test, the physical part under test, a real time response of the vehicle and/or the part, a time history of the responses of the vehicle and/or the part, etc.

Using the exemplary tester to perform tests does not require gathering road data with a full vehicle, and therefore allows earlier testing than otherwise possible. Furthermore, since the physical vehicle component or subsystem under test interacts with the simulation model through feedbacks, changes in the vehicle component or subsystem characteristics result in changes in the applied load or test conditions, as will happen on the real road.

It is understood that the testers disclosed herein are usable to test any types of subsystem of a vehicle, including active or passive suspension systems, active roll control systems, braking assistance systems, active steering systems, active ride height adjustment systems, all wheel drive systems, traction control systems, etc. It is also understood that the testers disclosed herein are suitable for testing various types/models of vehicles, such as automobiles, boats, bicycles, trucks, vessels, airplanes, trains, etc. Different variations and configurations of actuators and supporting posters can be used to implement the testers described in this disclosure.

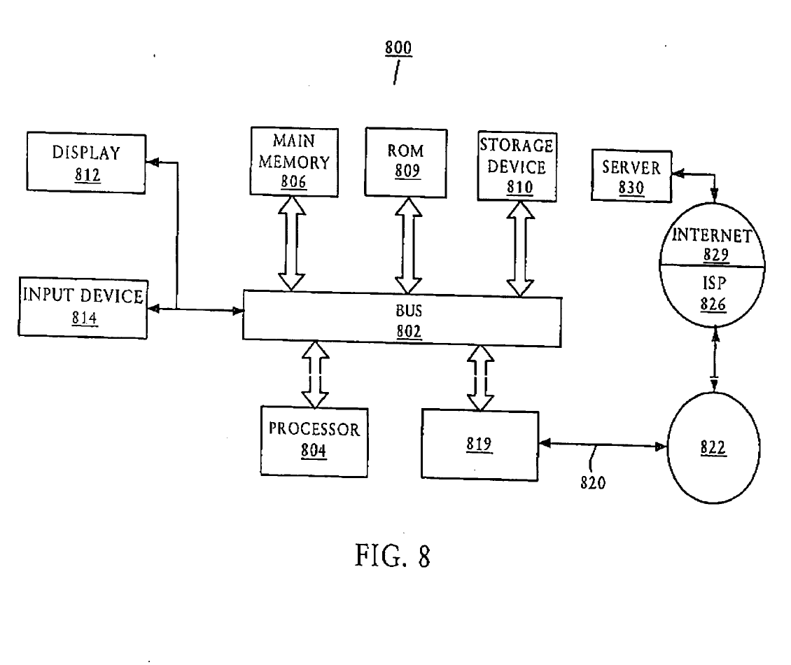

FIG. 8 is a block diagram that illustrates a data processing system 800 upon which a simulator of the disclosure may be implemented. Data processing system 800 includes a bus 802 or other communication mechanism for communicating information, and a processor 804 coupled with bus 802 for processing information. Data processing system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Data processing system 800 further includes a read only memory (ROM) 809 or other static storage device coupled to bus 802 for storing static information and instructions for processor 804. A storage device 810, such as a magnetic disk or optical disk, is provided and coupled to bus 802 for storing information and instructions.

Data processing system 800 may be coupled via bus 802 to a display 812, such as a cathode ray tube (CRT), for displaying information to an operator. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812.

The data processing system 800 is controlled in response to processor 804 executing one or more sequences of one or more instructions contained in main memory 806. Such instructions may be read into main memory 806 from another machine-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the disclosure. Thus, embodiments of the disclosure are not limited to any specific combination of hardware circuitry and software.

The term “machine readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 804 for execution. For example, the instructions may initially be carried on a magnetic disk of a remote data processing. The remote data processing system can load the instructions into its dynamic memory and send the instructions over a telephone line using a modem. A modem local to data processing system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Data processing system 800 also includes a communication interface 819 coupled to bus 802. Communication interface 819 provides a two-way data communication coupling to a network link that is connected to a local network 822. For example, communication interface 819 may be an integrated services digital network (ISDN) card or a modem to provide a data communication connection to a corresponding type of telephone line. As another example, communication interface 819 may be a local area network (LAN) card to provide a data communication connection to a compatible LAN. Wireless links may also be implemented. In any such implementation, communication interface 819 sends and receives electrical, electromagnetic or optical signals that carry digital data streams representing various types of information.

The network link typically provides data communication through one or more networks to other data devices. For example, the network link may provide a connection through local network 822 to a host data processing system or to data equipment operated by an Internet Service Provider (ISP) 826. ISP 826 in turn provides data communication services through the world wide packet data communication network now commonly referred to as the “Internet” 829. Local network 822 and Internet 829 both use electrical, electromagnetic or optical signals that carry digital data streams. The signals through the various networks and the signals on network link 820 and through communication interface 819, which carry the digital data to and from data processing system 800, are exemplary forms of carrier waves transporting the information.

Data processing system 800 can send messages and receive data, including program code, through the network(s), network link 820 and communication interface 819. In the Internet example, a server 830 might transmit a requested code for an application program through Internet 829, ISP 826, local network 822 and communication interface 819. In accordance with embodiments of the disclosure, one such downloaded application provides for automatic calibration of an aligner as described herein.

The data processing also has various signal input/output ports (not shown in the drawing) for connecting to and communicating with peripheral devices, such as USB port, PS/2 port, serial port, parallel port, IEEE-1394 port, infra red communication port, etc., or other proprietary ports. The measurement modules may communicate with the data processing system via such signal input/output ports.

The disclosure has been described with reference to specific embodiments thereof. It will, however, be evident that various modifications and changes may be made thereto without departing from the broader spirit and scope of the disclosure. The specification and drawings are, accordingly, to be regarded in an illustrative rather than a restrictive sense.

We claim:

1. A tester for simulating characteristics of a vehicle incorporating a subsystem under test, the tester comprising:
at least one test rig actuator configured to apply a test condition to the subsystem;
at least one sensor configured to collect signals related to the subsystem;
a data processing system including:
a data processor for processing data; and
a data storage device configured to store machine-executable instructions and data related to a simulation model representing the vehicle not including the subsystem, wherein the instructions, upon executed by the data processor, control the data processing system to perform the steps of:
generating a set of test signals based on the simulation model;
controlling the at least one test rig actuator to apply a test condition to the subsystem based on the test signals;
obtaining a response of the subsystem to the applied test conditions;
calculating effects of the subsystem to the vehicle using the simulation model incorporating information related to the response of the subsystem to the applied test condition; and
generating a result of the calculated effects.

2. The tester of claim 1, wherein:
the data related to the simulation model is modified based on the received response of the subsystem; and
the data processing system generates a new test signal using the modified simulation model of the vehicle, and controls the at least one actuator to apply a test condition to the subsystem based on the new test signal.

3. The tester of claim 1, wherein the data storage device stores data of simulation models representing at least one of a plurality of vehicle models, a plurality of test environments, a plurality of driver behaviors and a plurality of road conditions.

4. The tester of claim 1, wherein the subsystem includes at least one of a suspension system, at least one wheel and at least one tire.

5. The tester of claim 1, wherein the test condition includes applying at least one of a vertical displacement, a spin of a wheel of the subsystem, and one or more mutually orthogonal forces or moments.

6. The tester of claim 1, wherein the response of the subsystem includes at least one of a lateral force of a tire of the subsystem, a normal force of the tire of the subsystem, a deflection angle, a camber angle, a vertical force and aligning torque.

7. The tester of claim 1, wherein the data processing system generates a new set of test signals based on the obtained response of the subsystem.

8. The tester of claim 7, wherein the instructions, upon being executed by the data processor, further control the data processing system to control the at least one test rig actuator to apply a test condition to the subsystem based on the new set of test signals.

9. The tester of claim 1, wherein the generated result includes information related to at least one of fuel efficiency of the vehicle, ride comfort of the vehicle, needed time around a selected course, a travel distance, vehicle acceleration information, torque information, durability information, aerodynamics, and a brake distance.

10. A tester for simulating characteristics of a vehicle incorporating a subsystem under test, the tester comprising:
actuator means for applying a test condition to the subsystem;
sensing means for collecting signals related to the subsystem;
a data processing system including:
a data processor for processing data; and
data storage means for storing machine-executable instructions and data related to a simulation model representing the vehicle not including the subsystem, wherein the instructions, upon executed by the data processor, control the data processing system to perform the steps of:
generating a set of test signals based on simulation model;
controlling the actuator means to apply a test condition to the subsystem based on the test signals;
obtaining a response of the subsystem to the applied test condition;
calculating effects of the subsystem to the vehicle using the simulation model incorporating information related to the response of the subsystem to the applied test condition; and
generating a result of the calculated effects.

11. The tester of claim 10, wherein:
the data related to the simulation model is modified based on the received response of the subsystem; and
the data processing system generates a new test signal using the modified simulation model of the vehicle, and controls the actuator means to apply a test condition to the subsystem based on the new test signal.

12. The tester of claim 10, wherein the data storage means stores data of simulation models representing at least one of a plurality of vehicle models, a plurality of test environments, a plurality of driver behaviors and a plurality of road conditions.

13. The tester of claim 10, wherein the subsystem includes at least one of a suspension system, at least one wheel and at least one tire.

14. The tester of claim 10, wherein:
the test condition includes applying at least one of a vertical displacement, a spin of a wheel of the subsystem, a vertical force, a lateral force and a longitudinal force; and
the response of the subsystem includes at least one of a lateral force of a tire of the subsystem, a normal force of the tire of the subsystem, a deflection angle, a camber angle, a vertical force and aligning torque.

15. The tester of claim 10, wherein:
the data processing system generates a new set of test signals based on the obtained response of the subsystem; and
the instructions, upon being executed by the data processor, further control the data processing system to control the at least one test rig actuator to apply a test condition to the subsystem based on the new set of test signals.

16. The tester of claim 10, wherein the generated result includes information related to at least one of fuel efficiency of the vehicle, ride comfort of the vehicle, needed time around a selected course, a travel distance, vehicle acceleration information, torque information, durability information, aerodynamics, and a brake distance.

17. A method for evaluating characteristics of a vehicle incorporating a subsystem under test, the method comprising the machine-executed steps of:
providing a simulation model representing the vehicle not including the subsystem;
generating a set of test signals based on simulation model;
applying a test condition to the subsystem based on the test signals;
obtaining a response of the subsystem to the applied test condition;
calculating effects of the subsystem to the vehicle using the simulation model incorporating information related to the response of the subsystem to the applied test condition; and
generating a result of the calculated effects.

18. The method of claim 17 further comprising the step of modifying the simulation model based on the received response of the subsystem.

19. The method of claim 18 further comprising the steps of:
generating a new test signal using the modified simulation model of the vehicle, and applying a test condition to the subsystem based on the new test signal.

20. The method of claim 17, wherein the generated result includes information related to at least one of fuel efficiency of the vehicle, ride comfort of the vehicle, needed time around a selected course and a distance.
